(19) United States
(12) Patent Application Publication
(10) Pub. No.: US 2018/0056503 A1
(43) Pub. Date: Mar. 1, 2018

(54) ROBOT FOR MACHINE TOOL AND MACHINE TOOL

(71) Applicant: OKUMA Corporation, Niwa-gun (JP)

(72) Inventor: Shoichi MORIMURA, Niwa-gun (JP)

(21) Appl. No.: 15/689,594

(22) Filed: Aug. 29, 2017

(30) Foreign Application Priority Data
Aug. 29, 2016 (JP) 2016-166533

(51) Int. Cl. B25J 9/00; B25J 9/04; B25J 9/16; B25J 15/00; B25J 5/02; B25J 18/02

(52) U.S. Cl. CPC B25J 9/0015; B25J 9/047; B25J 9/0021; B23Q 7/046; B25J 15/0019; B25J 5/02; B25J 18/02; B25J 9/1674

(57) ABSTRACT

There is provided a robot for machine tool which can work with a large power and torque when necessary while not attaching a large-size motor to the robot and while having a thin arm, as well as a machine tool having the robot. An in-machine robot of a machine tool includes an input shaft, a transfer shaft, a bevel gear, and an end effector. The input shaft is connected to a tool of the machine tool, and a driving force of the tool is transferred to the end effector. The end effector is a hand or the like, and a workpiece is gripped or rotated with the hand using the driving force of the tool. A plurality of the input shafts are provided, and a suitable input shaft is connected to the tool as appropriate.

### CROSS REFERENCE TO RELATED APPLICATION

The present application claims priority under 35 U.S.C. § 119 to Japanese Patent Application No. 2016-166533, filed on Aug. 29, 2016, the entire content of which is incorporated herein by reference.

### TECHNICAL FIELD

The present disclosure relates to a robot for a machine tool, and to a machine tool.

### BACKGROUND

In the related art, machine tools which removal-machine a workpiece by means of a tool are known. In such machine tools, demands for automation and higher performance are increasing, and, in order to realize automation, some propose provision of a robot.

For example, JP 2010-36285 A discloses a technique for attaching and detaching a workpiece to and from a machine tool using a robot provided outside of the machine tool.

JP 2010-64158 A discloses a technique in which there is provided an articulated robot which travels on a gantry rail attached on an upper part of the machine tool, and the workpiece is transported or the like among a plurality of machine tools by the articulated robot. However, in general, a body part of the machine tool is covered with a cover in consideration of safety and the surrounding environment. Therefore, when an inside of a machining chamber is to be accessed using a robot provided at a location other than the body part of the machine tool as in JP 2010-36285 A and JP 2010-64158 A, a door of the machining chamber must be opened. Thus, with the robots of JP 2010-36285 A and JP 2010-64158 A, it is possible to attach or detach a workpiece when the workpiece is not being machined, but during machining; that is, in a state where the door of the machining chamber is closed, the robot cannot access the workpiece or the tool. As a result, the usages of the robot are limited with the techniques of JP 2010-36285 A and JP 2010-64158 A. In consideration of this, there also has been proposed providing the robot in the machining chamber.

For example, JP H5-301141 A and JP H5-301142 A disclose a workpiece transporting tool which transports the workpiece by an open/close operation of a gripping unit. The transporting tool has an arm shape, and is attached on a body function box. Further, the body function box is provided at a right side part of a spindle head which supports a spindle. The transporting tool can turn around an axis which is approximately orthogonal to a major axis of the spindle. The transporting tool is further configured to change, by the turning, between a state where the arm is approximately horizontal and a state where the arm is approximately vertical.

In a robot which is used for a machine tool, in many instances a relatively large power and a relatively large torque are demanded for transporting or machining a workpiece. On the other hand, in order to execute measurement of a complex workpiece or the like, the robot must enter a narrow space. For this purpose, the arm of the robot is desirably thin, and thus, attaching a large-size motor is difficult.

An advantage of the present disclosure lies in provision of a robot for a machine tool which can work with a large power and a large torque when necessary, while no large-size motor is attached to the robot and the robot has a thin arm, as well as a machine tool having such a robot.

### SUMMARY

According to one aspect of the present disclosure, there is provided a robot for a machine tool, comprising: an input shaft that enables input of a driving force of a rotary device of the machine tool by being connected to the rotary device; and a driven member that is driven by the driving force.

According to another aspect of the present disclosure, a plurality of the input shafts are provided.

According to another aspect of the present disclosure, the robot further comprises an internal motor, and the robot has at least a mode in which the driven member is driven by the internal motor, and a mode in which the driven member is driven by the driving force of the rotary device.

According to another aspect of the present disclosure, the driven member is an end effector.

According to another aspect of the present disclosure, the driven member is a joint.

According to another aspect of the present disclosure, a plurality of the input shafts and a plurality of the driven members are provided, and the input shafts and the driven members are in one of a one-to-one relationship, a one-to-N relationship, and an N-to-one relationship, wherein N is a natural number greater than or equal to 2.

According to another aspect of the present disclosure, the rotary device is one of a workpiece spindle device and a tool spindle device.

According to another aspect of the present disclosure, the robot is placed in a machining chamber of the machine tool.

According to another aspect of the present disclosure, there is provided a machine tool having the robot for machine tool in a machining chamber.

According to various aspects of the present disclosure, there can be provided a robot for a machine tool which can work with a large power and a large torque when necessary, without attaching a large-size motor on the robot, as well as a machine tool having such a robot.

### BRIEF DESCRIPTION OF DRAWINGS

Embodiment(s) of the present disclosure will be described by reference to the following figures, wherein:

FIG. 1 is a perspective view of a machine tool;

FIG. 2 is a first structural diagram of an in-machine robot;

FIG. 3 is a second structural diagram of the in-machine robot;

FIG. 4 is a third structural diagram of the in-machine robot;

FIG. 5 is a fourth structural diagram of the in-machine robot;

FIG. 6 is a first operation explanatory diagram of an in-machine robot;

FIG. 7 is a second operation explanatory diagram of the in-machine robot;

FIG. 8 is a third operation explanatory diagram of the in-machine robot;

FIG. 9 is a fourth operation explanatory diagram of the in-machine robot; and

FIG. 10 is a fifth operation explanatory diagram of the in-machine robot.

### DESCRIPTION OF EMBODIMENTS

An embodiment of the present disclosure will now be described with reference to the drawings.

### <Overall Structure>

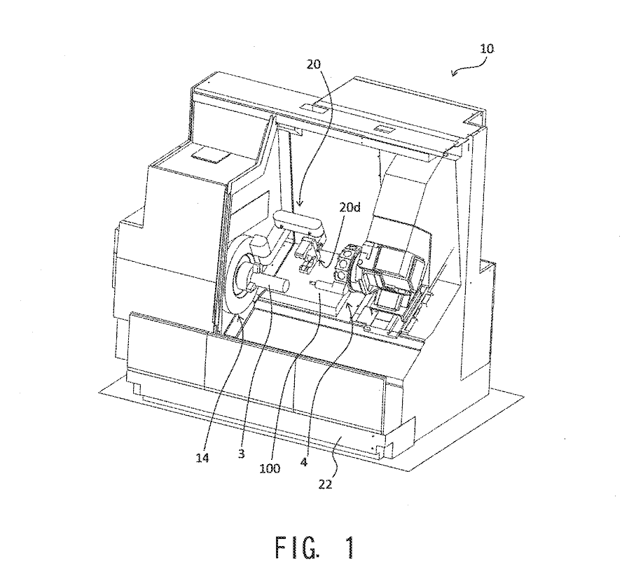

FIG. 1 is a diagram schematically showing a structure of a machine tool 10. In the following description, a rotation axis direction of a spindle device 14 will be referred to as a Z-axis, a movement direction of a tool post 4 orthogonal to the Z-axis will be referred to as an X-axis, and a direction orthogonal to the Z-axis and the X-axis will be referred to as a Y-axis.

The machine tool 10 is a machine which cut-machines a workpiece by means of a tool 100. More specifically, the machine tool 10 is a lathe having a lathe-turning function to cut the workpiece by causing a lathe-turning tool to contact the workpiece while rotating the workpiece. The tool post 4 of the machine tool 10 has a simple rotation-cutting function to cut the workpiece by rotating the workpiece.

A periphery of the machine tool 10 is covered by a cover (not shown). A space partitioned by the cover is a machining chamber where the machining of the workpiece is executed. By providing such a cover, spread of swarf or the like to the outside is prevented. On the cover, there are provided at least one opening, and a door which opens and closes the opening (both of which are not shown). An operator accesses the inside of the machine tool 10 and the workpiece, or the like through the opening. During machining, the door provided on the opening is closed. This is for the sake of safety and the surrounding environment.

The machine tool 10 comprises the workpiece spindle device 14 which retains a workpiece in a manner to allow self-rotation, and the tool post 4 which retains the tool 100 having its tip rotatable by the rotation-cutting function. The workpiece spindle device 14 comprises a head stock provided on a base 22, and a workpiece spindle attached on the head stock. The workpiece spindle has a chuck and/or a collet which detachably retains the workpiece, and a workpiece to be retained can be suitably exchanged. The workpiece spindle self-rotates around a workpiece rotation axis extending in the horizontal direction (Z-axis direction) as a center.

The tool post 4 retains a lathe-turning tool, such as a tool called a bite. The tool post 4 and the bite can linearly move in the X-axis and Z-axis directions by a drive mechanism.

At a bottom part in the machining chamber, there is provided a discharge mechanism which recovers and discharges swarf which is spread during the cut-machining. As the discharge mechanism, various forms may be considered. For example, the discharge mechanism is formed with a conveyer or the like which transports to the outside the swarf fallen due to the force of gravity.

The machine tool 10 comprises a control device which executes various calculations. The control device in the machine tool 10 is also called a numerical control device (NC), and controls driving of various parts of the machine tool 10 in response to an instruction from the operator. The control device comprises, for example, a CPU which executes various calculations, a memory which stores various control programs and control parameters, an input/output interface, an input device, and an output device. The input device is, for example, a touch panel and a keyboard, and the output device is, for example, a liquid crystal display and an organic EL display. Alternatively, both the input device and the output device may be formed with a touch panel. In addition, the control device has a communication function, and can exchange various data such as, for example, NC program data or the like, with other devices. The control device may include, for example, a numerical control device which calculates positions of the tool 100 and the workpiece at all times. Further, the control device may be a single device, or may be formed by combining a plurality of calculation devices.

The machine tool 10 further comprises an in-machine robot 20. The in-machine robot 20 comprises an input shaft, a joint, a node, and an end effector. The input shaft is connected to the tool 100, and a driving force for rotation-cut machining provided on the tool post 4 is transferred as a driving force of the in-machine robot 20.

In the present embodiment, a robot placed at a predetermined position in the machining chamber will be called an in-machine robot. The predetermined position does not necessary mean a fixed position, and includes a concept that the robot is placed at a certain position at an initial state and can be moved to a desired position during machining of the workpiece or other occasions.

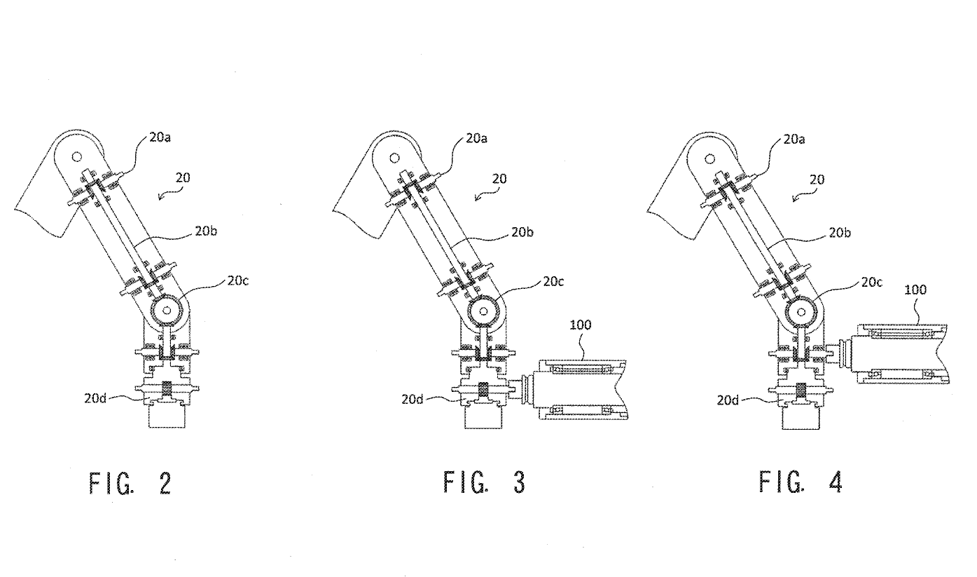

FIG. 2 is a structural diagram of the in-machine robot 20. The in-machine robot 20 comprises an input shaft 20a, a transfer shaft 20b, a bevel gear 20c, and an end effector 20d. In FIG. 2, a plurality (six) of input shafts 20a are provided. A tip of the input shaft 20a has a protruded shape, to engage with the spindle device 14.

When one of the plurality of input shafts 20a is connected to the tool 100, the driving force of the tool 100 which is input from the input shaft 20a is transferred to the end effector 20d of the in-machine robot 20 via the transfer shaft 20b and the bevel gear 20c. As shown in FIG. 1, a hand which grips a workpiece 3 may be attached to the end effector 20d, or a tool or various sensors may be attached to the end effector 20d. In the case of a hand, the workpiece 3 can be gripped or rotated with a large force, taking advantage of a relatively large torque of the tool 100.

Because the driving force for driving the end effector 20d is transferred from the tool 100, the machining or other works can be executed with a large power.

Because the input shafts 20a are provided at a plurality of locations, even when the orientation of the in-machine robot 20 changes, an input shaft 20a convenient for connection with the tool 100 may be selected, and the machining or other works can be executed.

Alternatively, the plurality of input shafts 20a may be provided separately for each function. For example, when a hand which grips the workpiece 3 is attached as the end effector 20d, input shafts may be provided such as an input shaft for inputting the driving force for the hand to grip the workpiece 3, an input shaft for inputting the driving force for the hand to rotate the workpiece 3, etc.

In the present embodiment, a plurality of combinations of the input shafts 20a and the end effectors 20d are provided so that distinctive usage of the end effectors 20d can be simply achieved without increasing the number of actuators. For example, a plurality of end effectors 20d may be provided as the end effector 20d, so that the plurality of input shafts 20a and the plurality of end effectors 20d correspond in a one-to-one relationship. Alternatively, other than such a configuration, a certain input shaft 20a may be provided corresponding to a plurality of end effectors 20d (one-to-N relationship), or a plurality of input shafts 20a may be provided corresponding to a certain end effector 20d (N-to-one relationship). Here, N is a natural number greater than or equal to 2.

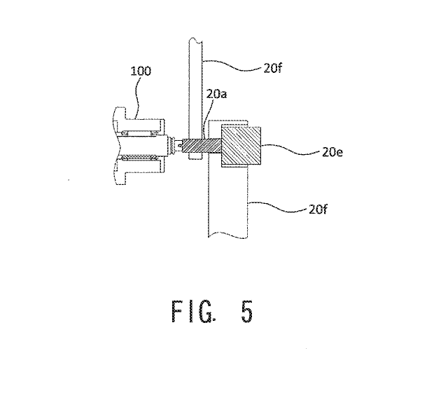

FIG. 5 shows a case where the driving force which is input from the input shaft 20a is used for a torque of a joint. An internal motor 20e for driving the joint is provided in the in-machine robot 20, and the shaft of the internal motor 20e is common with the input shaft 20a. Reference numeral 20f shows a node of the in-machine robot 20.

By sharing the input shaft 20a and the shaft of the internal motor 20a in this manner, it becomes possible to support the work using the rotary driving force of the tool 100 when the power and torque are insufficient with the internal motor 20e alone, and a large force can consequently be generated. With such a configuration, a high-load machining and transport of a heavy object can be enabled. The in-machine robot 20 may be considered to have three modes including: (1) a mode for driving with the driving force of the internal motor 20e alone; (2) a mode for driving with the driving force of the tool 100 alone; and (3) a mode for driving with the driving force of the internal motor 20e and the driving force of the tool 100.

In the present embodiment, because it is not necessary to provide a large-size motor or actuator in the in-machine robot 20, the arm of the in-machine robot 20 may be thinned to enable the robot to access various locations. In addition, a large power or torque can be utilized using the driving force of the tool 100 when necessary, but because the tool 100 is originally a necessary structure in the machine tool, the cost can be reduced.

An operation of the in-machine robot 20 in the present embodiment will now be described exemplifying a case where a hand is used as the end effector 20d (hereinafter referred to as “hand 20d”).

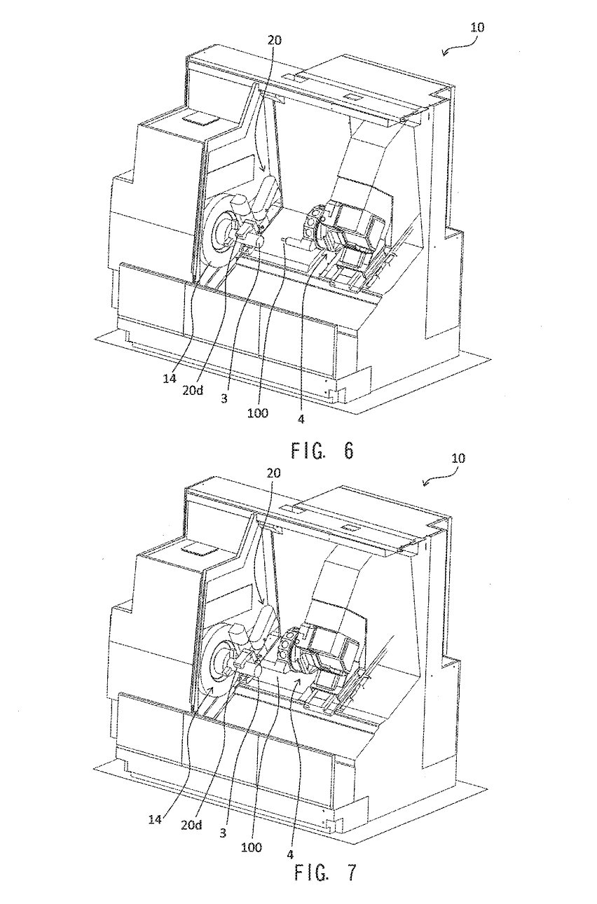

FIG. 6 shows a state where the in-machine robot 20 is moved to a gripping position of the workpiece 3. When the initial position of the in-machine robot 20 is the position shown in FIG. 1, the in-machine robot 20 moves to the position of the FIG. 6 only by the driving force of the internal motor 20e provided inside the in-machine robot 20. In the initial position of FIG. 1 and the state of FIG. 6, the input shaft 20a of the in-machine robot 20 is not necessarily connected to the tool 100. This means that, when the hand 20d serving as the end effector 20d is not used, the input shaft 20a of the in-machine robot 20 is separated from the tool 100, and the in-machine robot 20 can be freely moved.

FIG. 7 shows a state where the hand 20d is operated to open and close, from the state of FIG. 6, to grip the workpiece 3. In this case, as shown in FIG. 3, of the plurality of input shafts 20a of the in-machine robot 20, an input shaft 20a for opening and closing the hand is connected to the tool 100, the driving force of the tool 100 is transferred to the hand 20d via the input shaft 20a, the transfer shaft 20b, and the bevel gear 20c, and the driving force of the tool 100 is used to operate the hand 20d to open and close, to grip the workpiece 3.

After the hand 20d is closed to grip the workpiece 3, the closed state is maintained by activating a brake mechanism provided inside the hand 20d. With such a configuration, even when the connection state between the tool 100 and the input shaft 20a is released, the state of gripping the workpiece 3 is maintained.

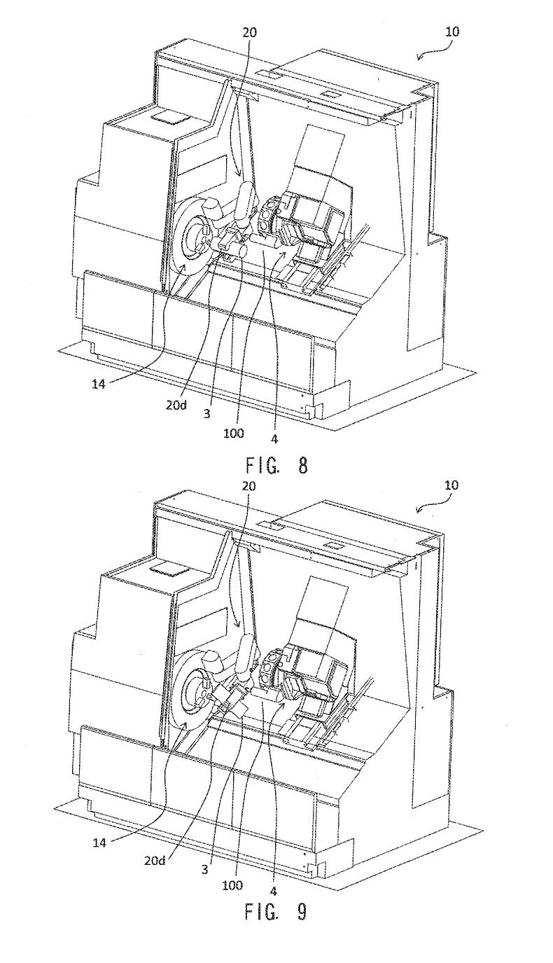

FIG. 8 shows a state where, after the workpiece is gripped, an input shaft 20a for flipping the workpiece 3, among the plurality of input shafts 20a of the in-machine robot 20, is connected to the tool 100, as shown in FIG. 4.

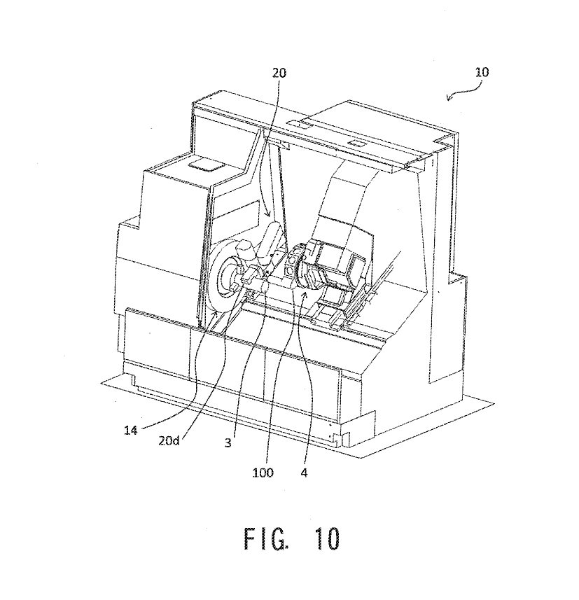

FIG. 9 shows a state during the flipping of the workpiece 3 from the state of FIG. 8. The driving force of the tool 100 is transferred to the hand 20d via the input shaft 20a, the transfer shaft 20b, and the bevel gear 20c, and the workpiece 3 is flipped while the workpiece is gripped.

FIG. 10 shows a state where, after the workpiece 3 is flipped, the hand 20d is opened to release the workpiece 3. The workpiece 3 is retained by a chuck of the spindle device 14, an input shaft 20a for opening and closing the hand among the plurality of input shafts 20a of the in-machine robot 20 is connected to the tool 100, the driving force of the tool 100 is transferred to the hand 20d via the input shaft 20a, the transfer shaft 20b, and the bevel gear 20c, and the driving force of the tool 100 is used to open the hand 20d and to consequently release the workpiece 3. The workpiece 3 is set in a state of being retained by the chuck.

An embodiment of the present disclosure has been described. The present disclosure, however, is not limited to the embodiment, and various modifications may be made. Modified, alternative configurations will now be described.

### <Alternative Configuration 1>

In the above description, the driving force from the tool 100 is transferred to the end effector 20d or the joint via the transfer shaft 20b and the bevel gear 20c, but alternatively, a reduction gear may be further provided on the path from the tool 100 to the end effector 20d or the joint, to easily obtain a larger force. In addition, the driving force may be transferred by a method other than rotation such as with use of a link mechanism.

### <Alternative Configuration 2>

In the above description, the input shaft 20a of the in-machine robot 20 is connected to the tool 100, but the connection target of the input shaft 20a is not necessarily limited to the tool 100, and the input shaft 20a may be connected to the tool post 4, and a turning torque of the tool post 4 may be utilized. In summary, it is sufficient that the in-machine robot 20 be connected to the rotary device of the machine tool and transfer the driving force of the rotary device to the end effector 20d and the joint, and various rotary devices may be employed for this purpose.

### <Alternative Configuration 3>

In the above description, the connection between the input shaft 20a of the in-machine robot 20 and the tool 100 is achieved by engagement between the protrusion on the tip of the input shaft 20a and the tool 100. Alternatively, the connection may be achieved via a flexible shaft, a universal joint, a coupling, or the like.

### <Alternative Configuration 4>

In the above description, an in-machine robot 20 provided in the machining chamber of the machine tool is exemplified, but the robot is not limited to a robot in the machining chamber, and the technique may be applied to a robot for a machine tool provided outside of the machining chamber. The robot may have an input shaft 20a and an internal motor 20e, and may have three modes including a mode for operating with only the internal motor 20e, a mode for operating using the driving force of the rotary device by connecting the input shaft 20a to a rotary device such as the tool 100, and a mode for using both the driving forces of the internal motor and the rotary device.

1. A robot for a machine tool, comprising:
an input shaft that enables input of a driving force of a rotary device of the machine tool by being connected to the rotary device; and
a driven member that is driven by the driving force.

2. The robot for machine tool according to claim 1, wherein
a plurality of the input shafts are provided.

3. The robot for machine tool according to claim 1, further comprising
an internal motor, wherein
the robot has at least a mode in which the driven member is driven by the internal motor, and a mode in which the driven member is driven by the driving force of the rotary device.

4. The robot for machine tool according to claim 1, wherein
the driven member is an end effector.

5. The robot for machine tool according to claim 1, wherein
the driven member is a joint.

6. The robot for machine tool according to claim 1, wherein
a plurality of the input shafts and a plurality of the driven members are provided, and
the input shafts and the driven members are in one of a one-to-one relationship, a one-to-N relationship, and an N-to-one relationship, wherein N is a natural number greater than or equal to 2.

7. The robot for machine tool according to claim 1, wherein
the rotary device is one of a workpiece spindle device and a tool spindle device.

8. The robot for machine tool according to claim 1, wherein
the robot for machine tool is placed in a machining chamber of the machine tool.

9. A machine tool comprising:
the robot for machine tool according to claim 1 in a machining chamber.
